(19) United States
(12) Patent Application Publication
(10) Pub. No.: US 2015/0303048 A1
(43) Pub. Date: Oct. 22, 2015

(54) FLASH LIGHT DISCHARGE TUBE AND STROBE DEVICE PROVIDED WITH SAME

(71) Applicant: Panasonic Intellectual Property Management Co., Ltd., Osaka (JP)

(72) Inventor: Rie YAMAMOTO, Kyoto (JP)

(21) Appl. No.: 14/734,168

(22) Filed: Jun. 9, 2015

Related U.S. Application Data
(63) Continuation of application No. 14/004,192, filed on Sep. 10, 2013, now abandoned.

(30) Foreign Application Priority Data
Mar. 28, 2011 (JP) 2011-0699229

(51) Int. Cl. H01J 61/35; H01J 61/90; H01J 61/36

(52) U.S. Cl. CPC H01J 61/35; H01J 61/366; H01J 61/90

(57) ABSTRACT

A flash discharge tube includes a cylindrical glass bulb filled with a rare gas; a pair of main electrodes sealed to both ends of the glass bulb via bead glasses; rough surfaces formed at least in the regions to which the bead glasses are welded, the regions being on the outer circumferential surfaces of the pair of main electrodes; and hard microparticles adhered to the rough surfaces. The hard microparticles are embedded in the rough surfaces. This increases the connection strength between the bead glasses and the pair of main electrodes, thereby ensuring the sealing performance between the bead glasses and the pair of main electrodes.

This application is a continuation of U.S. patent application Ser. No. 14/004,192, filed Sep. 10, 2013, which is a U.S. National Phase Application of PCT International Application PCT/JP2012/002017, filed Mar. 23, 2012, which claims priority to JP Application No. 2011-069229, filed Mar. 28, 2011, the entire disclosures of which are incorporated herein by reference.

### TECHNICAL FIELD

The present invention relates to a flash discharge tube as the light source of a strobe device used for taking pictures, and also to a strobe device provided with the flash discharge tube.

### BACKGROUND ART

Conventionally, as the light source of a strobe device used for taking pictures, a flash discharge tube shown in FIGS. 2A to 2C is used.

The configuration of the conventional flash discharge tube will be now described with reference to FIGS. 2A to 2C.

FIG. 2A is a longitudinal sectional view of the conventional flash discharge tube. FIG. 2B is an enlarged sectional view of a portion B of FIG. 2A. FIG. 2C is an enlarged sectional view of a portion C of FIG. 2A.

As shown in FIG. 2A, typical conventional flash discharge tube 100 includes cylindrical glass bulb 2 filled with at least a rare gas, and a pair of main electrodes 50 and 60 sealed to both ends of glass bulb 2 via bead glasses 3 and 4 (see, for example, Patent Literature 1).

The pair of main electrodes 50 and 60 are bar-shaped and made of metal materials. Main electrode 50 has one end which projects into glass bulb 2 and to which sintered metal body 8 is attached. Thus, main electrode 50 forms a cathode, and main electrode 60 forms an anode.

In flash discharge tube 100 having the above-described configuration, the circumference of glass bulb 2 is heated while bead glasses 3, 4 having main electrodes 50, 60 inserted therein are fitted in the openings of glass bulb 2. As a result, the inner circumferential surface of glass bulb 2 and the outer circumferential surfaces of bead glasses 3 and 4 are welded to each other. At the same time, the inner circumferential surfaces of bead glasses 3, 4 and the outer circumferential surfaces of main electrodes 50, 60 are welded to each other.

Glass bulb 2 and bead glasses 3, 4 are made of materials of the same kind. Therefore, heating glass bulb 2 as described above allows bead glasses 3, 4 and glass bulb 2 to be melted together, ensuring the sealing performance. On the other hand, bead glasses 3, 4 and main electrodes 50, 60 are made of different materials. Therefore, bead glasses 3, 4 and main electrodes 50, 60 are not melted together, causing the sealing performance not to be as high as between glass bulb 2 and bead glasses 3, 4.

To reduce this problem, as shown in FIGS. 2B and 2C, in conventional flash discharge tube 100, the outer circumferential surfaces of main electrodes 50, 60 to which bead glasses 3, 4 are bonded include rough surfaces 9. Providing rough surfaces 9 increases the bonding area between bead glasses 3, 4 and main electrodes 50, 60, thereby improving the sealing performance between bead glasses 3, 4 and main electrodes 50, 60.

However, this sealing performance between bead glasses 3, 4 and main electrodes 50, 60 in flash discharge tube 100 is still not enough. As a result, there are cases where the rare gas sealed in glass bulb 2 leaks through rough surfaces 9 between bead glasses 3, 4 and main electrodes 50, 60. The reason for this is as follows. An increase in the bonding area between main electrodes 50, 60 and bead glasses 3, 4 has been achieved by forming rough surfaces 9 on the outer circumferential surfaces of main electrodes 50, 60. However, rough surfaces 9 on the outer circumferential surfaces of main electrodes 50, 60 are comparatively smooth on average, thereby not ensuring the connection strength (bond strength) between bead glasses 3, 4 and main electrodes 50, 60. This results in defective sealing between bead glasses 3, 4 and main electrodes 50, 60 even in flash discharge tube 100 including main electrodes 50, 60 having rough surfaces 9 on their outer circumferential surfaces.

### CITATION LIST

### Patent Literature

Patent Literature 1: Japanese Unexamined Patent Publication No. 2006-244896

### SUMMARY OF THE INVENTION

In order to solve the above-described problem, the flash discharge tube of the present invention includes a cylindrical glass bulb filled with a rare gas; a pair of main electrodes sealed to both ends of the glass bulb via bead glasses; rough surfaces formed at least in regions to which the bead glasses are welded, the regions being on the outer circumferential surfaces of the pair of main electrodes; and hard microparticles adhered to the rough surfaces. The hard microparticles are embedded in the rough surfaces.

Hence, the bead glasses surround the hard microparticles, whereas the hard microparticles project into the bead glasses so as to function as anchors of the bead glasses, thereby increasing the connection strength between the main electrodes and the bead glasses. This improves the adhesion and bonding between the bead glasses and the main electrodes, ensuring the sealing performance between the bead glasses and the main electrodes.

The strobe device of the present invention includes the above-described flash discharge tube. This achieves a long-lived reliable strobe device.

### BRIEF DESCRIPTION OF DRAWINGS

FIG. 1A is a longitudinal sectional view of a flash discharge tube according to an exemplary embodiment of the present invention.

FIG. 1B is an enlarged sectional view of a portion B of FIG. 1A.

FIG. 1C is an enlarged sectional view of a portion C of FIG. 1A.

FIG. 2A is a longitudinal sectional view of a conventional flash discharge tube.

FIG. 2B is an enlarged sectional view of a portion B of FIG. 2A.

FIG. 2C is an enlarged sectional view of a portion C of FIG. 2A.

### DESCRIPTION OF EMBODIMENT

A flash discharge tube and a strobe device according to an exemplary embodiment of the present invention will now be described with reference to drawings. Note that in the following description, the same or equivalent components are denoted by the same reference numerals.

### Exemplary Embodiment

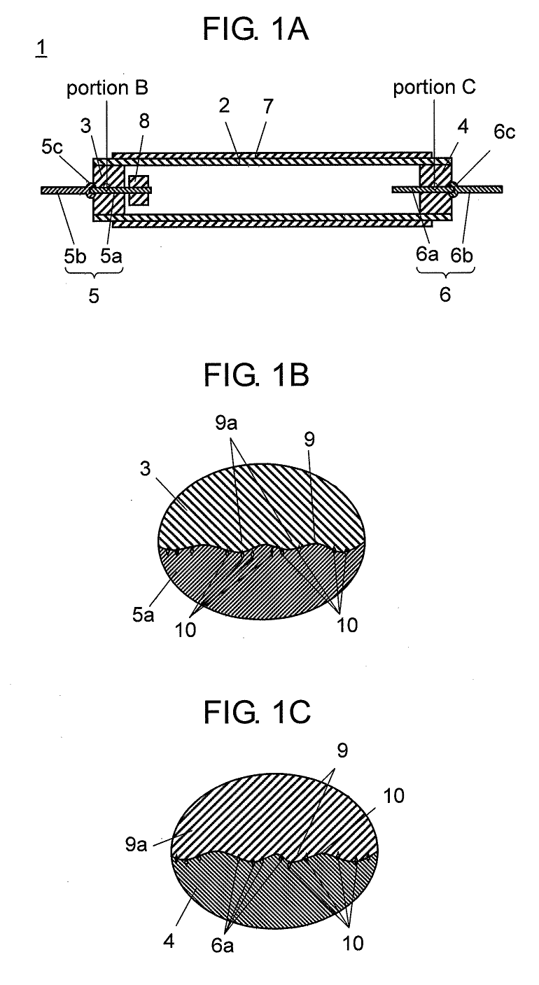

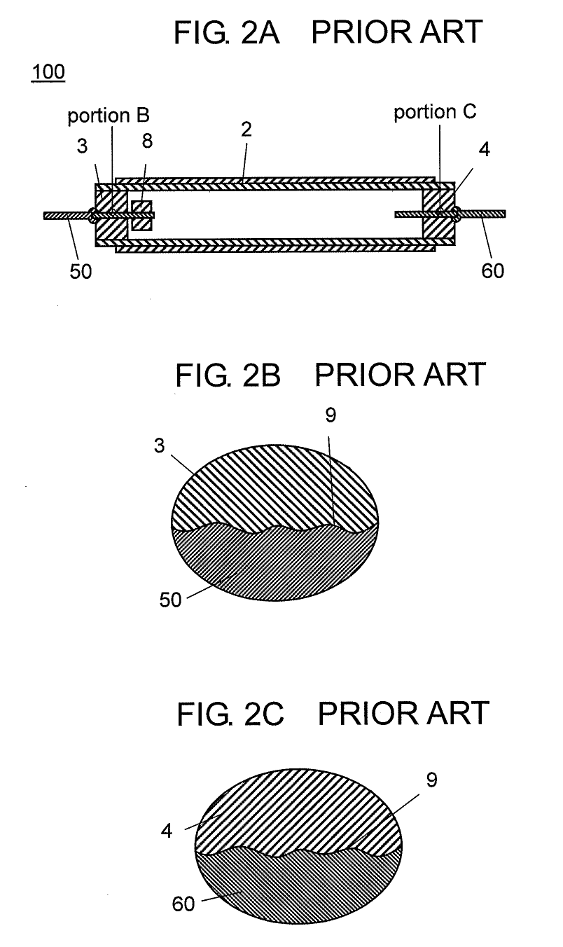

The flash discharge tube of the exemplary embodiment of the present invention will now be described with reference to FIGS. 1A to 1C. The flash discharge tube of the present exemplary embodiment is generally used as the light source of a strobe device.

FIG. 1A is a longitudinal sectional view of the flash discharge tube according to the exemplary embodiment of the present invention. FIG. 1B is an enlarged sectional view of a portion B of FIG. 1A. FIG. 1C is an enlarged sectional view of a portion C of FIG. 1A.

As shown in FIGS. 1A to 1C, flash discharge tube 1 of the present exemplary embodiment includes cylindrical glass bulb 2 filled with at least a rare gas; and a pair of main electrodes 5 and 6 sealed to both ends of glass bulb 2 via bead glasses 3 and 4.

Glass bulb 2 has a cylindrical body and is made of glass such as quartz. On the outer circumferential surface of glass bulb 2 is provided trigger electrode 7. Trigger electrode 7 is made of a conductive transparent film such as indium-tin oxide (ITO) or zinc oxide, and is formed on the outer circumferential surface of glass bulb 2. When a high-frequency voltage is applied from a trigger circuit (not shown) to trigger electrode 7, the rare gas sealed in glass bulb 2 is excited, allowing flash discharge tube 1 to emit light.

The pair of main electrodes 5 and 6 are each formed in the shape of a bar by connecting two bars made of different metals from each other in the axial direction. More specifically, main electrodes 5 and 6 are formed by connecting bar-shaped tungsten pins 5a and 6a made of tungsten with bar-shaped nickel pins 5b and 6b made of nickel. Tungsten pins 5a, 6a and nickel pins 5b, 6b are welded to each other by being arranged concentrically to each other and butted at their ends. As a result of welding, one end of each of tungsten pins 5a and 6a is stuck in one end of each of nickel pins 5b and 6b so as to connect tungsten pins 5a, 6a and nickel pins 5b, 6b to each other. One end of each of nickel pins 5b and 6b of main electrodes 5 and 6 has a larger diameter than the remaining portion, so that main electrodes 5 and 6 have large-diameter portions 5c and 6c at some midpoint of main electrodes 5 and 6 in the axial direction. Hence, tungsten pins 5a, 6a and nickel pins 5b, 6b are connected to each other via large-diameter portions 5c, 6c, thereby forming the pair of main electrodes 5, 6.

Bead glasses 3 and 4 seal both ends of glass bulb 2 (cylindrical body) made of, for example, borosilicate glass containing aluminum oxide, so that the rare gas is sealed in glass bulb 2. Tungsten pin 5a of main electrode 5 is liquid-tightly inserted in bead glass 3 along the above-mentioned axial direction of glass bulb 2. Similarly, tungsten pin 6a of main electrode 6 is liquid-tightly inserted in bead glass 4 along the axial direction of glass bulb 2. Thus, the pair of main electrodes 5 and 6 are disposed so that one end of each of tungsten pins 5a and 6a projects into glass bulb 2. On the other hand, nickel pins 5b and 6b each configure an external terminal which is extended to the outside of glass bulb 2 and connected to a wire or the like.

In the pair of main electrodes 5 and 6, large-diameter portions 5c, 6c of nickel pins 5b, 6b disposed at some midpoint main of electrodes 5 and 6 in the axial direction are come into contact with bead glasses 3, 4. This allows the positioning of one end of each of tungsten pins 5a and 6a inserted in bead glasses 3 and 4 at a predetermined position inside glass bulb 2.

Of the pair of main electrodes 5 and 6, main electrode 5 is attached with sintered metal body 8 at one end thereof that is inside glass bulb 2. Sintered metal body 8 is made of, for example, tantalum. Thus, main electrode 5, which includes sintered metal body 8 attached to the end of tungsten pin 5a connected to nickel pin 5b, forms an anode. On the other hand, main electrode 6, which includes tungsten pin 6a and nickel pin 6b connected to each other, forms a cathode.

As shown in FIGS. 1B and 1C, rough surfaces 9 are formed at least in the regions to which bead glasses 3 and 4 are to be welded, the regions being on the outer circumferential surfaces of tungsten pins 5a, 6a connected to nickel pins 5b, 6b of main electrodes 5, 6. Rough surfaces 9 formed on the outer circumferential surfaces of tungsten pins 5a, 6a have a large number of hard microparticles 10 distributed to be embedded in rough surfaces 9 (especially, in depressed portions 9a). Hard microparticles 10 are made of, for example, aluminum oxide and have a size in the range of 5 μm to 10 μm. Hard microparticles 10 are distributed to be embedded in rough surfaces 9 formed on the outer circumferential surfaces of tungsten pins 5a, 6a so that tungsten pins 5a, 6a of main electrodes 5, 6 can be liquid-tightly inserted in bead glasses 3, 4.

As will be described in detail in Example below, it is preferable that hard microparticles 10 be present in 1.03% to 2.34% of rough surfaces 9 of main electrodes 5 and 6. In other words, it is preferable that the large number of hard microparticles 10 be distributed and adhered to the coverage of the adhesion in the range of 1.03% to 2.34% of the surface area of rough surfaces 9 formed on the outer circumferential surfaces of main electrodes 5 and 6.

The following is a description of how rough surfaces 9 are formed on the outer circumferential surfaces of tungsten pins 5a, 6a, and how hard microparticles 10 are made to be embedded in rough surfaces 9 of the outer circumferential surfaces of tungsten pins 5a, 6a.

First, hard materials (hard granular materials such as aluminum oxide), which become hard microparticles 10, are applied to the outer circumferential surfaces of tungsten pins 5a, 6a of main electrodes 5, 6 by, for example, shot blasting with high pressure and at a jet velocity of 50 m/sec or so. The surface-treatment by shot blasting may be applied either to tungsten pins 5a, 6a of main electrodes 5, 6 or to tungsten pins 5a, 6a before being formed into main electrodes 5, 6.

In this treatment, the hard granular materials bump into the outer circumferential surfaces of either main electrodes 5, 6 or of the metal bars to be formed into main electrodes 5, 6. These outer circumferential surfaces become rough surfaces 9. Then, the microparticles (hard microparticles 10) contained in the hard granular materials or the microparticles (hard microparticles 10) into which the hard granular materials are crushed after bumping into the outer circumferential surfaces are distributed to be embedded in the outer circumferential surfaces (depressed portions 9a of rough surfaces 9) of either main electrodes 5, 6 or of the metal bars to be formed into main electrodes 5, 6.

As a result, rough surfaces 9 are formed on the outer circumferential surfaces of main electrodes 5 and 6, and at the same time, hard microparticles 10 are distributed to be embedded in rough surfaces 9.

Thus, according to the present exemplary embodiment, hard microparticles 10 such as aluminum oxide are sprayed to tungsten pins 5a, 6a, so that rough surfaces 9 are formed on the outer circumferential surfaces of tungsten pins 5a, 6a of main electrodes 5, 6. At the same time, a large number of hard microparticles 10 made of aluminum oxide are distributed to be embedded in the outer circumferential surfaces (depressed portions 9a) of tungsten pins 5a, 6a of main electrodes 5, 6. As a result, in some cases, all of the large number of hard microparticles 10 are embedded deep into tungsten pins 5a, 6a. In other cases, some of hard microparticles 10 project from the outer circumferential surfaces of tungsten pins 5a, 6a, while others are embedded deep into tungsten pins 5a, 6a.

Then, bead glasses 3, 4 are made to closely adhere to main electrodes 5, 6 (tungsten pins 5a, 6a) along the shapes of the outer circumferential surfaces of main electrodes 5, 6. More specifically, bead glasses 3, 4 are heat-melted as described above, thereby being welded to the openings of glass bulb 2 (cylindrical body) and main electrodes 5, 6. As a result, bead glasses 3, 4 are formed to closely adhere to rough surfaces 9 of main electrodes 5, 6 and also to hard microparticles 10 distributed to be embedded in rough surfaces 9.

Bead glasses 3 and 4 surround hard microparticles 10, whereas hard microparticles 10 project into the bead-glasses 3, 4 so as to function as anchors of bead glasses 3, 4. This increases the connection strength between the outer circumferential surfaces of main electrodes 5, 6 and bead glasses 3, 4, thereby improving the adhesion and bonding between the outer circumferential surfaces of main electrodes 5, 6 and bead glasses 3, 4. As a result, the sealing performance between bead glasses 3, 4 and main electrodes 5, 6 is ensured to prevent leakage of the rare gas sealed in glass bulb 2.

The flash discharge tube of the present exemplary embodiment is obtained as described above.

The above-described flash discharge tube of the present exemplary embodiment can be used in a strobe device so as to achieve a long-lived reliable strobe device.

As described hereinbefore, according to the present exemplary embodiment, rough surfaces 9 are formed at least in the regions to which bead glasses 3, 4 are to be welded, the regions being on the outer circumferential surfaces of main electrodes 5, 6. Then, hard microparticles 10 are distributed to be embedded in rough surfaces 9. This increases the connection strength between bead glasses 3, 4 and main electrodes 5, 6. As a result, the sealing performance between bead glasses 3, 4 and main electrodes 5, 6 is ensured to prevent leakage of the rare gas sealed in glass bulb 2, thereby achieving a long-lived reliable flash discharge tube.

According to the present exemplary embodiment, microparticles such as aluminum oxide contained in the bead glasses can be used as hard microparticles 10 so that hard microparticles 10 can be easily intermingled with bead glasses 3, 4. This results in an improvement in the bonding and adhesion between main electrodes 5, 6 and bead glasses 3, 4.

According to the present exemplary embodiment, hard microparticles 10 are distributed and adhered to the coverage of the adhesion in the range of 1.03% to 2.34% of the surface area of rough surfaces 9 of main electrodes 5 and 6. This increases the connection strength between bead glasses 3, 4 and main electrodes 5, 6 so as to prevent product failure due to leakage of the rare gas. As a result, a low-cost flash discharge tube can be manufactured at a high production rate.

Note that the present invention is not limited to the above-described exemplary embodiment, and can be modified within its scope.

More specifically, in the above description of the present exemplary embodiment, shot blasting is used to form rough surfaces 9 on the outer circumferential surfaces of main electrodes 5, 6, and at the same time, to embed hard microparticles 10 in rough surfaces 9. Instead, the following alternative method can be used. First, rough surfaces 9 are formed on the outer circumferential surfaces of main electrodes 5, 6 by rubbing or pressing the metal material used for main electrodes 5, 6 either against each other or against another material. Then, hard microparticles 10 are pressed against rough surfaces 9 of main electrodes 5 and 6, thereby being embedded therein.

In the above description of the present exemplary embodiment, main electrodes 5, 6 are formed by butting tungsten pins 5a, 6a and nickel pins 5b, 6b against each other, but this is not the only option available. Alternatively, main electrodes 5 and 6 may be made of only one metal material such as tungsten or another metal material. In this case, however, it is preferable that the material have the same or similar coefficient of thermal expansion to the material of bead glasses 3, 4 at least in those regions of main electrodes 5, 6 which are to be welded to bead glasses 3, 4.

In the above description of the present exemplary embodiment, hard microparticles 10 are made of aluminum oxide, but this is not the only option available. Alternatively, hard microparticles 10 may be made of a hard metal material such as tungsten carbide (WC) or titanium carbide (TiC), or an inorganic material such as industrial diamond or ceramic. In this case, it is preferable that hard microparticles 10 be hard enough to be embedded in the outer circumferential surfaces of main electrodes 5, 6 when pushed or blown against these surfaces.

The following is a description of a specific example in which tests were conducted to examine the relationship between the condition of distribution (the coverage of adhesion) of the hard microparticles and the condition of leakage of the rare gas (leakage from between the main electrodes and the bead glasses) in the flash discharge tube according to the present invention. Note that the present invention is not limited to the Example shown below, but can be implemented within its scope by, for example, changing materials to be used.

### EXAMPLE

First, flash discharge tubes were prepared as samples. In these flash discharge tubes, rough surfaces are formed in those regions of the outer circumferential surfaces of the tungsten pins of the main electrodes which are to be adhered to the bead glasses, and hard microparticles made of aluminum oxide (alumina) are distributed to be embedded in the depressed portions of the rough surfaces of the tungsten pins.

Next, the prepared flash discharge tubes were subjected to a high-temperature high-humidity test (at a temperature of 65° C., a humidity of 95%, a time period of 1000 h) to evaluate leakage of the rare gas from between the bead glasses and the main electrodes.

Then, the prepared flash discharge tubes were subjected to scanning electron microscopy/energy dispersive X-ray Spectroscopy (SEM-EDS) to measure the coverage of adhesion (%) of the hard microparticles in five points (a first point to a fifth point) on the outer circumferential surfaces of the main electrodes. The average of the coverage of adhesion (%) at the five points was calculated as the coverage of adhesion (%) per unit area of the hard microparticles of each of the prepared flash discharge tubes. The surface analysis using the scanning electron microscope was performed at a magnification of 2000 times with a measurement depth of about 1 μm and a measurement range of 3000 μm² at each point.

Table 1 and Table 2 below show the measurement results of the coverage of adhesion of the hard microparticles of each flash discharge tube prepared as the samples.

TABLE 1

| | | | | | | average coverage of |
|---|---|---|---|---|---|---|
| sample | 1st | 2nd | 3rd | 4th | 5th | adhesion per flash |
| No. | point | point | point | point | point | discharge tube (%) |
| 1 | 1.18 | 1.21 | 1.22 | 1.26 | 1.28 | 1.23 |
| 2 | 1.30 | 1.30 | 1.32 | 1.32 | 1.36 | 1.32 |
| 3 | 1.39 | 1.42 | 1.44 | 1.49 | 1.51 | 1.45 |
| 4 | 1.75 | 1.76 | 1.82 | 1.83 | 1.89 | 1.81 |
| 5 | 2.30 | 2.33 | 2.34 | 2.35 | 2.38 | 2.34 |
| 6 | 1.00 | 1.01 | 1.02 | 1.05 | 1.07 | 1.03 |
| 7 | 1.04 | 1.08 | 1.11 | 1.12 | 1.15 | 1.10 |
| 8 | 1.12 | 1.16 | 1.17 | 1.19 | 1.21 | 1.17 |
| 9 | 1.18 | 1.22 | 1.23 | 1.29 | 1.33 | 1.25 |
| 10 | 1.71 | 1.75 | 1.80 | 1.86 | 1.88 | 1.80 |

TABLE 2

| | | | | | | average coverage of |
|---|---|---|---|---|---|---|
| sample | 1st | 2nd | 3rd | 4th | 5th | adhesion per flash |
| No. | point | point | point | point | point | discharge tube (%) |
| 11 | 0.72 | 0.73 | 0.79 | 0.86 | 0.90 | 0.80 |
| 12 | 0.90 | 0.94 | 0.94 | 0.96 | 0.96 | 0.94 |
| 13 | 0.91 | 0.95 | 0.99 | 1.00 | 1.05 | 0.98 |
| 14 | 0.95 | 0.96 | 0.96 | 1.01 | 1.02 | 0.98 |
| 15 | 0.98 | 1.00 | 1.00 | 1.01 | 1.01 | 1.00 |
| 16 | 0.37 | 0.45 | 0.53 | 0.56 | 0.59 | 0.50 |
| 17 | 0.50 | 0.56 | 0.58 | 0.63 | 0.68 | 0.59 |
| 18 | 0.66 | 0.69 | 0.72 | 0.75 | 0.83 | 0.73 |
| 19 | 0.67 | 0.74 | 0.78 | 0.83 | 0.88 | 0.78 |
| 20 | 0.71 | 0.76 | 0.80 | 0.85 | 0.88 | 0.80 |

The results of the high-temperature high-humidity test indicate that no leakage of the rare gas was detected from the flash discharge tubes of Samples Nos. 1 to 10 where the hard microparticles had the average coverage of adhesions in the range of 1.03% to 2.34% as shown in Table 1. On the other hand, leakage of the rare gas from between the bead glasses and the main electrodes was detected from 35% of the flash discharge tubes of Samples Nos. 11 to 20 where the hard microparticles had the average coverage of adhesions in the range of 0.50% to 1.00% as shown in Table 2.

When the high-temperature high-humidity test was applied to the flash discharge tubes where the hard microparticles had an the average coverage of adhesion of 0% and their main electrodes had rough surfaces, almost all the samples had leakage of the rare gas from between the bead glasses and the main electrodes.

Thus, it has been found that leakage of the rare gas from between the main electrodes and the bead glasses can be greatly reduced by making the hard microparticles be embedded in the main electrodes. More specifically, when the coverage of adhesion (%) of the hard microparticles per unit area is in the range of 1.03% to 2.34%, product failure (flash discharge tubes causing leakage of the rare gas from between the bead glasses and the main electrodes) can be prevented. It has also been found that when the coverage of adhesions (%) of the hard microparticles per unit area is in the range of 0.5% to 1.00%, product failure can be slightly reduced.

These results indicate that in terms of preventing leakage of the rare gas from between the bead glasses and the main electrodes, hard microparticles are made to be embedded in the outer circumferential surfaces of the main electrodes so as to greatly reduce leakage of the rare gas.

On the other hand, it has been confirmed that in terms of preventing product failure of the flash discharge tube, it is safe to use main electrodes having hard microparticles whose the coverage of adhesions (%) per unit area are in the range of 1.03% to 2.34%.

As described above, the flash discharge tube of the present invention includes a cylindrical glass bulb filled with a rare gas; a pair of main electrodes sealed to both ends of the glass bulb via bead glasses; rough surfaces formed at least in regions to which the bead glasses are welded, the regions being on the outer circumferential surfaces of the pair of main electrodes; and hard microparticles adhered to the rough surfaces. The hard microparticles are embedded in the rough surfaces.

With this configuration, the hard microparticles are distributed at least in regions to which the bead glasses are to be welded, the regions being on the outer circumferential surfaces (rough surfaces) of the main electrodes. The hard microparticles are made to be embedded in the rough surfaces. As a result, the bead glasses are made to closely adhere to the outer circumferential surfaces of the main electrodes along the shapes of the rough surfaces formed on the outer circumferential surfaces. Thus, the bead glasses are adhered closely to the main electrodes along the shapes of the rough surfaces of the main electrodes and the shapes of the hard microparticles distributed over the rough surfaces and embedded in the rough surfaces.

Hence, the bead glasses surround the hard microparticles, whereas the hard microparticles project into the bead glasses so as to function as anchors of the bead glasses, thereby increasing the connection strength between the main electrodes and the bead glasses. This improves the adhesion and bonding between the bead glasses and the main electrodes, ensuring the sealing performance between the bead glasses and the main electrodes in the flash discharge tube.

In the flash discharge tube of the present invention, the hard microparticles are made of aluminum oxide. This allows the bead glasses and the hard microparticles to be easily intermingled with each other, thereby improving the bonding and adhesion between main electrodes 5, 6 and bead glasses 3, 4.

In the flash discharge tube of the present invention, the aluminum oxide has an identical composition to aluminum oxide contained in the bead glasses. As a result, at least the surface layers of the bead glasses and the main electrodes can be made of the same materials, thereby improving the bonding and adhesion between the bead glasses and the main electrodes.

In the flash discharge tube of the present invention, the hard microparticles have a coverage of adhesion in the range of 1.03% to 2.34% of the area of the rough surfaces on the main electrodes. This optimizes the connection strength between the bead glasses and the main electrodes.

In addition, the strobe device of the present invention includes the above-described flash discharge tube. This achieves a long-lived reliable strobe device.

### INDUSTRIAL APPLICABILITY

The flash discharge tube of the present invention ensures the sealing performance between the bead glasses and the main electrodes by increasing the connection strength between the bead glasses and the main electrodes. Hence, the flash discharge tube is useful as the light source of a strobe device used for taking pictures.

### REFERENCE MARKS IN THE DRAWINGS

1, 100 flash discharge tube
2 glass bulb
3, 4 bead glass
5, 6, 50, 60 main electrode
5a, 6a tungsten pin
5b, 6b nickel pin
5c, 6c large-diameter portion
7 trigger electrode
8 sintered metal body
9 rough surface
9a depressed portion
10 hard microparticle

1. A flash discharge tube comprising:
a cylindrical glass bulb filled with a rare gas;
a pair of main electrodes sealed to both ends of the glass bulb via bead glasses;
rough surfaces formed at least in regions to which the bead glasses are welded, the regions being on outer circumferential surfaces of the pair of main electrodes; and hard microparticles adhered to the rough surfaces,
wherein the hard microparticles are embedded in the rough surfaces.

2. The flash discharge tube of claim 1, wherein
the hard microparticles are made of aluminum oxide.

3. The flash discharge tube of claim 2, wherein
the aluminum oxide has an identical composition to aluminum oxide contained in the bead glasses.

4. The flash discharge tube of claim 1, wherein
the hard microparticles have a coverage of adhesion in a range of 1.03% to 2.34% of an area of the rough surfaces on the main electrodes.

5. A strobe device comprising the flash discharge tube of claim 1.
